(19) United States
(12) Patent Application Publication
(10) Pub. No.: US 2018/0278728 A1
(43) Pub. Date: Sep. 27, 2018

(54) SYSTEM AND METHOD FOR SWITCHING COMMUNICATION PROTOCOL BETWEEN TWO DEVICES

(71) Applicant: SMARTRON INDIA PRIVATE LIMITED, Hyderabad (IN)

(72) Inventors: ANIL KONGOVI, Bangalore (IN); ROHIT RATHI, Bangalore (IN)

(21) Appl. No.: 15/761,949

(22) PCT Filed: Sep. 20, 2016
(86) PCT No.: PCT/IN2016/000230

§ 371 Date: Mar. 21, 2018

(30) Foreign Application Priority Data
Sep. 22, 2015 (IN) 506/CHE/2015

(51) Int. Cl. H04L 29/06

(52) U.S. Cl. CPC H04L 69/24; H04L 69/18

(57) ABSTRACT

The various embodiments herein provide a system and method for changing the means of communication between two devices by switching between several communication protocols depending on the proximity between devices. The embodiments herein automatically switch between a plurality of communication protocols between two devices based on preset triggers. The embodiments herein enables automatic switching of one or more combination of communication mediums or protocols such as Wi-Fi, WiGig, Wired, Bluetooth, NFC, IR, Sensors, HDMI, USB, MHL, NFC etc. The embodiments herein also automatically switches one communication protocol to another communication protocol based on change in the bandwidth of communication and without disconnecting or affecting the data transfer.

### CROSS REFERENCE TO RELATED APPLICATIONS

This patent application is a National Phase application corresponding to the PCT Application No. PCT/IN2016/000230 filed on Sep. 20, 2016 with the title “SYSTEM AND METHOD FOR SWITCHING COMMUNICATION PROTOCOL BETWEEN TWO DEVICES”. This patent application claims the priority of the Indian Provisional Patent Application No. 5064/CHE42015 filed on Sep. 22, 2015 with the title “SYSTEM AND METHOD FOR SWITCHING COMMUNICATION PROTOCOL BETWEEN DRIVE AND DISPLAY DEVICES”, the contents of which is included herein by the way of reference.

### BACKGROUND

### Technical Field

The embodiments herein are generally related to communication protocols in computing devices. The embodiments herein are particularly related to a system and method for switching communication protocols between two devices. The embodiments herein are more particularly related to a system and method for automatically switching a communication protocol between two devices based on preset triggers.

### Description of the Related Art

With increasing use of multiple handheld computing devices and cloud based data storage techniques, the need for connecting the multiple devices to one another has also been increased. Although wireless connection is used increasingly between the devices, some applications demand a wired connection between computing devices. A user switches between the multiple communication protocols depending on the nature of the task to be accomplished by connecting the devices.

Currently, a user manually chooses and establishes a communication protocol for sharing information between two or more devices. The currently available methods do not offer an automatic method for changing the communication connection or protocol between two devices based on the context.

Hence, there is a need for a system and method for automatically switching a communication protocol between two devices to enabling an effective data transfer. There is also a need for a system and method to identify the best communication protocol available for a given context depending on a plurality of factors.

The abovementioned shortcomings, disadvantages and problems are addressed herein and which will be understood by reading and studying the following specification.

### OBJECTIVES OF THE EMBODIMENTS HEREIN

The primary object of the embodiments herein is to provide a system and method for changing the means of communication between two devices by switching between a plurality of communication protocols.

Another objective of embodiments herein is to provide a system and method to automatically switch between a plurality of communication protocols between two devices based on preset triggers.

Yet another objective of embodiments herein is to provide a system and method for automatically switching the communication protocol to enable an effective data transfer between two devices.

Yet another objective of embodiments herein is to provide a system and method for automatically switching the communication protocol to enable data transfer between two devices based on the proximity between the devices.

Yet another objective of embodiments herein is to provide a method to identify the best communication protocol for a given context depending on a plurality of factors.

Yet another objective of embodiments herein is to provide a system and method to optimize the communication between a plurality of devices by choosing contextually appropriate communication protocol through present rules and triggers.

Yet another objective of embodiments herein is to switch one communication protocol to another communication protocol automatically without disconnecting or affecting the data transfer.

Yet another objective of embodiments herein is to switch one communication protocol to another communication protocol automatically based on a change in the bandwidth of communication.

Yet another objective of embodiments herein is to switch automatically among one or more combination of communication mediums or protocols such as Wi-Fi, WiGig, Wired, Bluetooth, NFC, IR, Sensors, HDMI, USB, MHL, NFC etc.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and method for changing the means of communication between two devices by switching between a plurality of communication protocols. The embodiments herein are more particularly related to a system and method for automatically switching between a plurality of communication protocols between two devices based on preset triggers.

According to one embodiment herein, a system is provided for changing the modes of communication between two devices. The system comprises a computing device, a connecting device and a plurality of communication modules. The connecting device is communicatively connected to the computing device through a plurality of communication protocols. The connecting device and the computing device are connected through a wired or wireless network. The plurality of communication modules are configured to support a plurality of protocols. The computing device and the connecting device are configured to connect with one another through any one of the plurality of the communication protocols based on a plurality of parameters. The computing device is configured to contextually identify and switch to any one of the plurality of communication protocols to achieve an optimal level of communication.

According to one embodiment herein, the computing device is configured to contextually switch to any one of the plurality of communication protocols to connect with the connecting device based on a plurality of parameters. The plurality of parameters comprises a residual battery capacity of the computing device, a residual battery capacity of the connecting device, a signal strength of a communication medium or protocol, a physical barrier or interference between the computing device and the connecting device, a proximity level between the computing device and the connecting device, a persona of the computing device and the connecting device, a data processing performance at any instant, a data usage level at any instant, and a user information.

According to one embodiment herein, the connecting device and the computing device are not connected through internet. An Internet Protocol (IP) address is not assigned to the connecting device or computing device, when the computing device and the connecting device are not connected through internet.

According to one embodiment herein, the communication established between the computing device and the connecting device is not disconnected during a switching of a communication protocol.

According to one embodiment herein, the computing device and the connecting device are communicatively connected through a plurality of modes based on a selected communication protocol.

According to one embodiment herein, the plurality of modes comprises a physically connected usage mode, a high bandwidth usage mode, a low bandwidth usage mode, and a standby or doze usage mode.

According to one embodiment herein, the computing device and the connecting device are connected through any one of the plurality of communication protocols comprising magnetic connection, USB connection, HDMI connection, MHL connection in the physically connected usage mode.

According to one embodiment herein, the computing device and the connecting device are connected through WiGig during the high bandwidth usage mode.

According to one embodiment herein, the computing device and the connecting device are connected through any one of the plurality of communication protocols comprising Wi-Fi, Bluetooth, Bluetooth low energy during a low bandwidth usage mode.

According to one embodiment herein, the computing device and the connecting device are connected through any one of the communication protocols comprising Bluetooth low energy, Infra-red. Wi-Fi, push button control during the standby or doze usage mode.

According to one embodiment herein, a method is provided for changing the modes of communication between two devices. The method comprises the following steps: The computing device and the connecting device are activated. The communication protocol used for connecting the computing device and the connecting device is detected, and wherein the connecting device and the computing device are connected through a wired or wireless network. The alternate techniques or possibilities of connecting the connecting device to the computing device is searched for. The computing device is configured to contextually identify and switch to any one of the plurality of communication protocols to achieve an optimal level of communication. When the communication protocol to achieve an optimal level of communication is identified, the user is notified to switch communication protocols or automatically switching the communication protocol based on user preferences. The plurality of parameters that trigger the switching of communication protocol between the computing device and the connecting device are continuously monitored to achieve an optimal level of communication.

According to one embodiment herein, the computing device is configured to contextually switch to any one of the plurality of communication protocols to connect with the connecting device based on a plurality of parameters. The plurality of parameters comprises a residual battery capacity of the computing device, a residual battery capacity of the connecting device, a signal strength of a communication medium or protocol, a physical barrier or interference between the computing device and the connecting device, a proximity level between the computing device and the connecting device, a persona of the computing device and the connecting device, a data processing performance at any instant, a data usage level at any instant, and a user information.

According to one embodiment herein, the connecting device and the computing device are not connected through internet. An Internet Protocol (1P) address is not assigned to the connecting device or computing device when the computing device and the connecting device are not connected through internet.

According to one embodiment herein, the communication established between the computing device and the connecting device is not disconnected during a switching of a communication protocol.

According to one embodiment herein, the computing device and the connecting device are communicatively connected through a plurality of modes based on a selected communication protocol.

According to one embodiment herein, the plurality of modes comprises a physically connected usage mode, a high bandwidth usage mode, a low bandwidth usage mode, and a standby or doze usage mode.

According to one embodiment herein, the computing device and the connecting device are connected through any one of the plurality of communication protocols comprising magnetic connection, USB connection, HDMI connection, MHL connection in the physically connected usage mode.

According to one embodiment herein, the computing device and the connecting device are connected through WiGig during the high bandwidth usage mode.

According to one embodiment herein, the computing device and the connecting device are connected through any one of the plurality of communication protocols comprising Wi-Fi, Bluetooth, Bluetooth low energy during a low bandwidth usage mode.

According to one embodiment herein, the computing device and the connecting device are connected through any one of the communication protocols comprising Bluetooth low energy, Infra-red, Wi-Fi, push button control during the standby or doze usage mode.

According to one embodiment herein, a method to switch a communication protocol between a plurality of connected devices is provided. The method involves connecting a computing device to a connecting device through one of the communication protocols supported by the devices. When the proximity between the devices is varied, a communication protocol set between the devices is also switched. The switching between a plurality of communication protocols is performed, when a communication interference or physical barrier for interrupting between the devices and the current protocol does not ensure effective connectivity. Protocol switching also occurs when bandwidth is reduced due to over-crowding of a particular communication band due to the increased use/sharing of a same communication protocol by multiple devices.

According to one embodiment herein, a system for switching a communication protocol between two devices is provided. The two devices includes a computing device and a connecting device. A computing device is communicatively connected to a connecting device through a communication protocol. When the proximity between the computing device and connecting device is changed, the communication protocol between the computing device and the connecting device is also automatically switched. The one or more combinations of communication mediums or protocols is selected from a group consisting of Wi-Fi, WiGig, Wired, Bluetooth, NFC. IR, Sensors, HDMI, USB, MHL, NFC etc.

According to one embodiment herein, a method for switching a communication protocol between a plurality of devices is provided. The method comprises the following steps. The computing device and a communicatively connected connecting device are operated. The type of communication protocol existing between the computing device and drive/connecting device is detected. The alternate communication protocols used for communicatively connecting the connecting device to the computing device are searched. When an alternate communication protocol for optimizing the performance of the system and/or enhance the user experience is detected, the user is notified to switch a communication protocol or automatically select an alternate communication protocol available based on user preferences. The triggers and other preset conditions for protocol switching is constantly monitored during a change in proximity levels.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a system for switching a communication protocol between a plurality of devices, according to one embodiment herein.

FIG. 2 illustrates a flow chart explaining the process steps involved in a method for switching a communication protocol between a plurality of devices, according to one embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for changing the means of communication between two devices by switching between a plurality of communication protocols. The embodiments herein are more particularly related to a system and method for automatically switching between a plurality of communication protocols between two devices based on preset triggers.

According to one embodiment herein, a system is provided for changing the modes of communication between two devices. The system comprises a computing device, a connecting device and a plurality of communication modules. The connecting device is communicatively connected to the computing device through a plurality of communication protocols. The connecting device and the computing device are connected through a wired or wireless network. The plurality of communication modules are configured to support a plurality of protocols. The computing device and the connecting device are configured to connect with one another through any one of the plurality of the communication protocols based on a plurality of parameters. The computing device is configured to contextually identify and switch to any one of the plurality of communication protocols to achieve an optimal level of communication.

According to one embodiment herein, the computing device is configured to contextually switch to any one of the plurality of communication protocols to connect with the connecting device based on a plurality of parameters. The plurality of parameters comprises a residual battery capacity of the computing device, a residual battery capacity of the connecting device, a signal strength of a communication medium or protocol, a physical barrier or interference between the computing device and the connecting device, a proximity level between the computing device and the connecting device, a persona of the computing device and the connecting device, a data processing performance at any instant, a data usage level at any instant, and a user information.

According to one embodiment herein, the connecting device and the computing device are not connected through internet. An Internet Protocol (IP) address is not assigned to the connecting device or computing device, when the computing device and the connecting device are not connected through internet.

According to one embodiment herein, the communication established between the computing device and the connecting device is not disconnected during a switching of a communication protocol.

According to one embodiment herein, the computing device and the connecting device are communicatively connected through a plurality of modes based on a selected communication protocol.

According to one embodiment herein, the plurality of modes comprises a physically connected usage mode, a high bandwidth usage mode, a low bandwidth usage mode, and a standby or doze usage mode.

According to one embodiment herein, the computing device and the connecting device are connected through any one of the plurality of communication protocols comprising magnetic connection, USB connection, HDMI connection, MHL connection in the physically connected usage mode.

According to one embodiment herein, the computing device and the connecting device are connected through WiGig during the high bandwidth usage mode.

According to one embodiment herein, the computing device and the connecting device are connected through any one of the plurality of communication protocols comprising Wi-Fi, Bluetooth, Bluetooth low energy during a low bandwidth usage mode.

According to one embodiment herein, the computing device and the connecting device are connected through any one of the communication protocols comprising Bluetooth low energy, Infra-red, Wi-Fi, push button control during the standby or doze usage mode.

According to one embodiment herein, a method is provided for changing the modes of communication between two devices. The method comprises the following steps: The computing device and the connecting device are activated. The communication protocol used for connecting the computing device and the connecting device is detected, and wherein the connecting device and the computing device are connected through a wired or wireless network. The alternate techniques or possibilities of connecting the connecting device to the computing device is searched for. The computing device is configured to contextually identify and switch to any one of the plurality of communication protocols to achieve an optimal level of communication. When the communication protocol to achieve an optimal level of communication is identified, the user is notified to switch communication protocols or automatically switching the communication protocol based on user preferences. The plurality of parameters that trigger the switching of communication protocol between the computing device and the connecting device are continuously monitored to achieve an optimal level of communication.

According to one embodiment herein, the computing device is configured to contextually switch to any one of the plurality of communication protocols to connect with the connecting device based on a plurality of parameters. The plurality of parameters comprises a residual battery capacity of the computing device, a residual battery capacity of the connecting device, a signal strength of a communication medium or protocol, a physical barrier or interference between the computing device and the connecting device, a proximity level between the computing device and the connecting device, a persona of the computing device and the connecting device, a data processing performance at any instant, a data usage level at any instant, and a user information.

According to one embodiment herein, the connecting device and the computing device are not connected through internet. An Internet Protocol (IP) address is not assigned to the connecting device or computing device when the computing device and the connecting device are not connected through internet.

According to one embodiment herein, the communication established between the computing device and the connecting device is not disconnected during a switching of a communication protocol.

According to one embodiment herein, the computing device and the connecting device are communicatively connected through a plurality of modes based on a selected communication protocol.

According to one embodiment herein, the plurality of modes comprises a physically connected usage mode, a high bandwidth usage mode, a low bandwidth usage mode, and a standby or doze usage mode.

According to one embodiment herein, the computing device and the connecting device are connected through any one of the plurality of communication protocols comprising magnetic connection, USB connection, HDMI connection, MHL connection in the physically connected usage mode.

According to one embodiment herein, the computing device and the connecting device are connected through WiGig during the high bandwidth usage mode.

According to one embodiment herein, the computing device and the connecting device are connected through any one of the plurality of communication protocols comprising Wi-Fi, Bluetooth, Bluetooth low energy during a low bandwidth usage mode.

According to one embodiment herein, the computing device and the connecting device are connected through any one of the communication protocols comprising Bluetooth low energy, Infra-red, Wi-Fi, push button control during the standby or doze usage mode.

According to one embodiment herein, a method to switch a communication protocol between a plurality of connected devices is provided. The method involves connecting a computing device to a connecting device through one of the communication protocols supported by the devices. When the proximity between the devices is varied, a communication protocol set between the devices is also switched. The switching between a plurality of communication protocols is performed, when a communication interference or physical barrier for interrupting between the devices and the current protocol does not ensure effective connectivity. Protocol switching also occurs when bandwidth is reduced due to over-crowding of a particular communication band due to the increased use/sharing of a same communication protocol by multiple devices.

According to one embodiment herein, a system for switching a communication protocol between two devices is provided. The two devices includes a computing device and a connecting device. A computing device is communicatively connected to a connecting device through a communication protocol. When the proximity between the computing device and connecting device is changed, the communication protocol between the computing device and the connecting device is also automatically switched. The one or more combinations of communication mediums or protocols is selected from a group consisting of Wi-Fi, WiGig, Wired, Bluetooth, NFC, IR, Sensors, HDMI, USB, MHL, NFC etc.

According to one embodiment herein, a method for switching a communication protocol between a plurality of devices is provided. The method comprises the following steps. The computing device and a communicatively connected connecting device are operated. The type of communication protocol existing between the computing device and drive/connecting device is detected. The alternate communication protocols used for communicatively connecting the connecting device to the computing device are searched. When an alternate communication protocol for optimizing the performance of the system and/or enhance the user experience is detected, the user is notified to switch a communication protocol or automatically select an alternate communication protocol available based on user preferences. The triggers and other preset conditions for protocol switching is constantly monitored during a change in proximity levels.

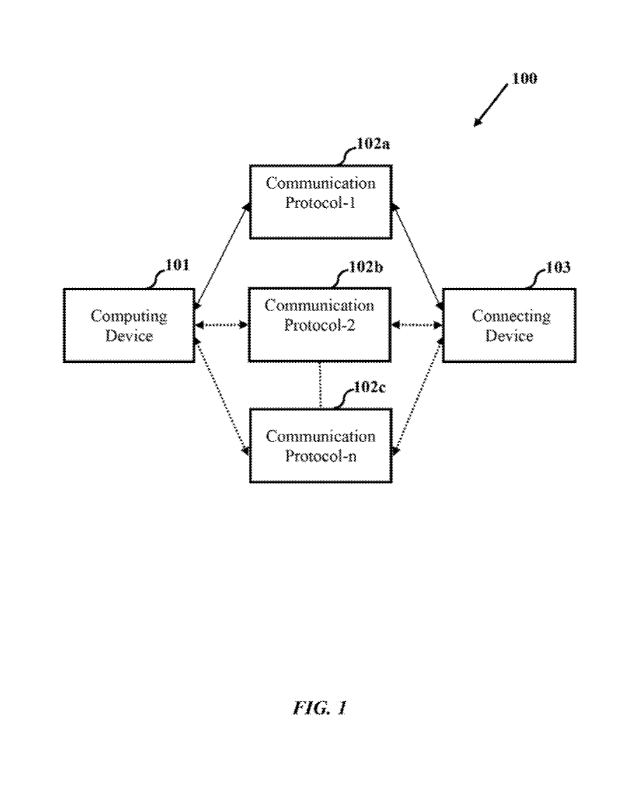

FIG. 1 illustrates a functional block diagram of a system for switching a communication protocol between a plurality of devices, according to one embodiment herein. A computing device 101 is connected to another device 103 through a communication protocol-1 102a. When the proximity between the computing device 101 and connecting device 103 is changed, the communication protocol between the computing device 101 and connecting device 103 is automatically switched from communication protocol-1 to any one of the communication protocols selected from a group consisting of a communication protocol-2 to a communication protocol-n. The communication protocol is automatically switched using one or more combinations of communication mediums or protocols selected from a group consisting of Wi-Fi, WiGig, Wired, Bluetooth, NFC, IR, Sensors, HDMI, USB, MHL, NFC etc.

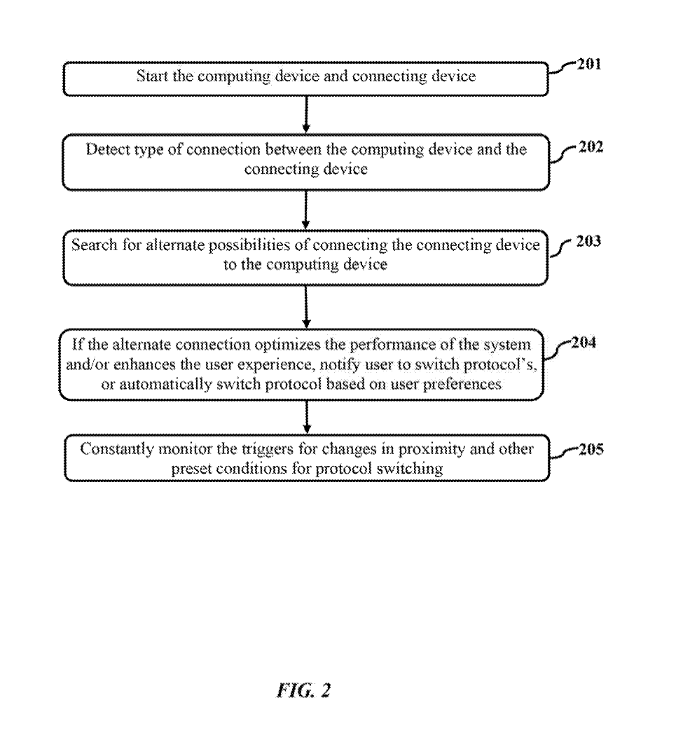

FIG. 2 illustrates a flow chart explaining the process steps involved in a method for switching a communication protocol between a plurality of devices, According to one embodiment herein. The method comprises the following steps. The computing device and a communicatively connected connecting device are operated (201). The type of communication protocol existing between the computing device and connecting device is detected (202). The alternate communication protocols used for communicatively connecting the connecting device to the computing device are searched (203). When an alternate communication protocol for optimizing the performance of the system and/or enhance the user experience is detected, the user is notified to switch a communication protocol or automatically select an alternate communication protocol available based on user preferences (204). The triggers and other preset conditions for protocol switching is constantly monitored during a change in proximity levels (205).

The embodiments herein provide a system and method for changing the means of communication between two devices by switching a communication protocol depending on the proximity between devices. The embodiments herein automatically switch a communication protocol between two devices based on preset triggers. The embodiments herein provide a system and method for a contextual and automated switching of protocols between multiple computing devices and drives. The embodiments herein also automatically switch one communication protocol to another communication protocol based on change in the bandwidth of communication and without disconnecting or affecting the data transfer. The embodiments herein enable automatic switching of one or more combination of communication mediums or protocols such as Wi-Fi, WiGig, Wired, Bluetooth, NFC, IR, Sensors, HDMI, USB, MHL, NFC etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the disclosure with modifications. However, all such modifications are deemed to be within the scope of the appended claims.

It is also to be understood that the following claims are intended to cover all of the generic and specific features of the embodiments described herein and all the statements of the scope of the embodiments which as a matter of language might be said to fall there between.

What is claimed is:

1. A system for changing the modes of communication between two devices, the system comprising:
a computing device;
a connecting device, and wherein the connecting device is communicatively connected to the computing device through a plurality of communication protocols, and wherein the connecting device and the computing device are connected through a wired or wireless network; and
a plurality of communication modules, and wherein the plurality of communication modules are configured to support a plurality of protocols, and wherein the computing device and the connecting device are configured to connect with one another through any one of the plurality of the communication protocols based on a plurality of parameters, and wherein the computing device is configured to contextually identify and switch to any one of the plurality of communication protocols to achieve an optimal level of communication.

2. The system according to claim 1, wherein the computing device is configured to contextually switch to any one of the plurality of communication protocols to connect with the connecting device based on a plurality of parameters, and wherein the plurality of parameters comprises a residual battery capacity of the computing device, a residual battery capacity of the connecting device, a signal strength of a communication medium or protocol, a physical barrier or interference between the computing device and the connecting device, a proximity level between the computing device and the connecting device, a persona of the computing device and the connecting device, a data processing performance at any instant, a data usage level at any instant, and a user information.

3. The system according to claim 1, wherein the connecting device and the computing device are not connected through internet, and wherein Internet Protocol (IP) address is not assigned to the connecting device or computing device, when the computing device and the connecting device are not connected through internet.

4. The system according to claim 1, wherein the communication established between the computing device and the connecting device is not disconnected during a switching of a communication protocol.

5. The system according to claim 1, wherein the computing device and the connecting device are communicatively connected through a plurality of modes based on a selected communication protocol.

6. The system according to claim 1, wherein the plurality of modes comprises a physically connected usage mode, a high bandwidth usage mode, a low bandwidth usage mode, and a standby or doze usage mode.

7. The system according to claim 1, wherein the computing device and the connecting device are connected through any one of the plurality of communication protocols comprising magnetic connection, USB connection, HDMI connection, MHL connection in the physically connected usage mode.

8. The system according to claim 1, wherein the computing device and the connecting device are connected through WiGig during the high bandwidth usage mode.

9. The system according to claim 1, wherein the computing device and the connecting device are connected through any one of the plurality of communication protocols comprising Wi-Fi, Bluetooth, Bluetooth low energy during a low bandwidth usage mode.

10. The system according to claim 1, wherein the computing device and the connecting device are connected through any one of the communication protocols comprising Bluetooth low energy, Infra-red, Wi-Fi, push button control. during the standby or doze usage mode.

11. A method for changing the modes of communication between two devices, the method comprising:
activating the computing device and the connecting device;
detecting the communication protocol connecting the computing device and the connecting device, and wherein the connecting device and the computing device are connected through a wired or wireless network;
searching for alternate possibilities of connecting the connecting device to the computing device, and wherein the computing device and the connecting device are configured to connect with one another through any one of the plurality of the communication protocols based on a plurality of parameters, and wherein the computing device is configured to contextually identify and switch to any one of the plurality of communication protocols to achieve an optimal level of communication;
when the communication protocol to achieve an optimal level of communication is identified, notifying user to switch communication protocols or automatically switching the communication protocol based on user preferences; and,
continuously monitoring the plurality of parameters that trigger the switching of communication protocol between the computing device and the connecting device to achieve an optimal level of communication.

12. The method according to claim 11, wherein the computing device is configured to contextually switch to any one of the plurality of communication protocols to connect with the connecting device based on a plurality of parameters, and wherein the plurality of parameters comprises a residual battery capacity of the computing device, a residual battery capacity of the connecting device, a signal strength of a communication medium or protocol, a physical barrier or interference between the computing device and the connecting device, a proximity level between the computing device and the connecting device, a persona of the computing device and the connecting device, a data processing performance at any instant, a data usage level at any instant, and a user information.

13. The method according to claim 11, wherein the connecting device and the computing device are not connected through internet, and wherein Internet Protocol (IP) address is not assigned to the connecting device or computing device, when the computing device and the connecting device are not connected through internet.

14. The method according to claim 11, wherein the communication established between the computing device and the connecting device is not disconnected during a switching of a communication protocol.

15. The method according to claim 11, wherein the computing device and the connecting device are communicatively connected through a plurality of modes based on a selected communication protocol.

16. The method according to claim 11, wherein the plurality of modes comprises a physically connected usage mode, a high bandwidth usage mode, a low bandwidth usage mode, and a standby or doze usage mode.

17. The method according to claim 11, wherein the computing device and the connecting device are connected through any one of the plurality of communication protocols comprising magnetic connection, USB connection, HDMI connection, MHL connection in the physically connected usage mode.

18. The method according to claim 11, wherein the computing device and the connecting device are connected through WiGig during the high bandwidth usage mode.

19. The method according to claim 11, wherein the computing device and the connecting device are connected through any one of the plurality of communication protocols comprising Wi-Fi, Bluetooth, Bluetooth low energy during a low bandwidth usage mode.

20. The method according to claim 11, wherein the computing device and the connecting device are connected through any one of the communication protocols comprising Bluetooth low energy, Infra-red, Wi-Fi, push button control during the standby or doze usage mode.
